(19) United States
(12) Patent Application Publication
(10) Pub. No.: US 2015/0257379 A1
(43) Pub. Date: Sep. 17, 2015

(54) COVERING FOR EDIBLE PRODUCT

(71) Applicant: Extreme Hunting Solutions, LLC, Centerville, IA (US)

(72) Inventor: Randall Ferman, Randolph, NJ (US)

(73) Assignee: EXTREME HUNTING SOLUTIONS, LLC, Centerville, IA (US)

(21) Appl. No.: 14/209,295

(22) Filed: Mar. 13, 2014

(51) Int. Cl. A01M 31/00

(52) U.S. Cl. CPC A01M 31/00

(57) ABSTRACT

The present invention is, in one embodiment, a covering for a solid, dissolvable edible product including a base having a front surface, a back surface, and at least one attachment element; a cover extending from the front surface of the base along at least a portion of the base; and a securing element extending from the front surface of the base. The present invention also includes various kits, systems, methods of manufacture and methods of use of the covering.

### BACKGROUND OF THE INVENTION

Edible products are often used by hunters to attract prey. In use, such edible products are strategically positioned to attract prey, such as deer, to a specific location where the hunter lies in wait. These edible products may be any type of hunting attractant such as a salt lick, an aromatic substance (e.g., vanilla extract, almond extract), molasses or sugar-based substances, plant materials and/or seeds, berries, peanut butter, any combination of the above, and the like.

Such edible products can be positioned on the ground, or supported on a solid object, such as a tree, rock, or the like. For example, certain products are formed as a solid mass which is secured to a solid object by a string, a screw, a strap or other fixation member. The solid mass (e.g., a salt lick or a solidified molasses-based mixture) is dissolvable such that the prey (e.g., a deer) can eat/lick the solid mass to obtain the contents.

However, such dissolvable edible products on the market have certain drawbacks. Perhaps most importantly, when using an attractant, the environment can affect its longevity. For example, a salt lick or a sugar-based mixture can quickly dissolve in the event of a rain or snow shower, as the water quickly dissolves the salt and/or sugar mass. As such, the hunter must install a new edible product and absorb the cost of the dissolved and wasted edible product.

The dissolvability of these solid masses is important, though, such that the prey can actually consume the content of the solid mass. As such, there is a need in the art for an improved way to use these edible products to minimize waste and cost.

### BRIEF SUMMARY OF THE INVENTION

The present invention is directed to a covering for use with a solid, dissolvable edible product, such as those described above. The purpose of the covering is to provide protection to the dissolvable edible product, from the environmental elements, but still allow for access by potential prey to the edible product being covered. The present invention, and use thereof, constitutes a marked advantage over traditional edible products used in hunting which were quickly dissolved and/or destroyed by the environment.

In one embodiment, the present invention is a covering for a solid, dissolvable edible product including a base and a cover. The covering may also include a securing element for fixedly securing the edible product. Both the cover and the securing element may extend from the base in the same direction.

In a further embodiment, the present invention is a covering for a solid, dissolvable edible product including a base having a front surface, a back surface, and at least one attachment element, a cover extending from the front surface of the base along at least a portion of the base, and a securing element extending from the front surface of the base. The at least one attachment element can be positioned within the base and/or through the securing element or cover. The covering can be combined with the edible product to form a system for use in attracting prey, such that the edible product may be a hunting attractant. Further, the edible product can be fixedly secured within an open volume partially defined by the base and the cover.

In another embodiment, the present invention is a covered solid, dissolvable edible product, including a base having a front surface, a back surface and a securing element extending from the front surface; and a cover extending from the front surface of the base and at least partially enclosing the securing element, wherein the solid dissolvable product is fixedly secured to the securing element.

In yet another embodiment, the present invention is a covered solid, dissolvable edible product including a covering having an open volume partially defined by a front surface of a base and a cover extending from the front surface of the base, the base having a securing element extending from the front surface, the securing element at least partially enclosed by the cover and the solid dissolvable product positioned within the open volume and fixedly secured to the securing element. The edible product can be a hunting attractant. The base, and/or the securing element or covering, can include at least one attachment element adapted to secure the base to a solid object, such as a tree trunk or the like.

In still a further embodiment, the present invention is a method of using a covered, solid, dissolvable edible product, the method including the steps of: obtaining the solid, dissolvable edible product and a covering, the covering comprising a base having a front surface and a back surface, and at least one attachment element, a cover extending from the front surface of the base along at least a portion of the base, and a securing element extending from the front surface of the base, the edible product fixedly secured on the securing element within an open volume partially defined by the base and the cover; and securing the covering and the edible product to a solid object using the at least one attachment element.

In another embodiment, the present invention is a method of manufacturing a covered, solid, dissolvable edible product, including the steps of: obtaining a liquid form of the solid, dissolvable edible product; obtaining a covering, the covering comprising a base having a front surface and a back surface, a cover extending from the front surface of the base along at least a portion of the base, and a securing element extending from the front surface of the base; positioning the covering relative to the liquid form of the solid, dissolvable edible product; and allowing the liquid form to harden into the solid, dissolvable edible product, wherein the allowing step secures the solid, dissolvable edible product onto the securing element within an open volume partially defined by the base and the cover.

The present invention also includes other embodiments including kits and systems including at least one covering and at least one solid, dissolvable edible product, as well as embodiments of methods of making and using such systems and kits.

### BRIEF DESCRIPTION OF THE DRAWINGS

FIGS. 1-3 illustrate one embodiment of a covering of the present invention.

FIG. 4 illustrates the covering of FIGS. 1-3 positioned with a solid, dissolvable edible product.

FIG. 5 illustrates another embodiment of a covering of the present invention.

FIG. 6 illustrates the covering of FIG. 5 positioned with a solid, dissolvable edible product.

FIGS. 7-9 illustrate a further embodiment of a covering of the present invention.

FIG. 10 illustrates the covering of FIGS. 7-9 positioned with a solid, dissolvable edible product.

FIG. 11 illustrates still another embodiment of a covering of the present invention positioned with a solid, dissolvable edible product.

FIG. 12 illustrates a cross-sectional view of the covering and solid, dissolvable edible product of FIG. 11.

### DETAILED DESCRIPTION

The covering of the present invention is intended to be used with any type of edible product used in hunting, though the covering has particular effectiveness with edible products that are susceptible to the environmental elements of the outdoors, such as rain and snow. As such, the exemplary edible product discussed with the various embodiments below will be in the form of a solid, dissolvable edible product, such as a salt lick, a molasses or sugar-based substance, or the like. Such solid edible products can include any other ingredients desired, as discussed above, and can be positioned underneath the covering, and secured thereto, such that at least a portion, such as at least a portion of the underside and/or at least a portion of the front surfaces of the solid mass, remains exposed to allow access for the potential prey.

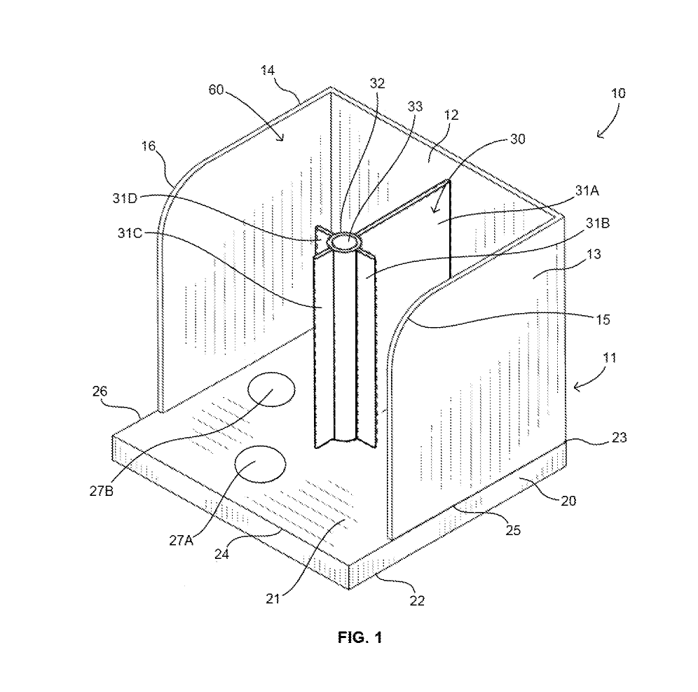

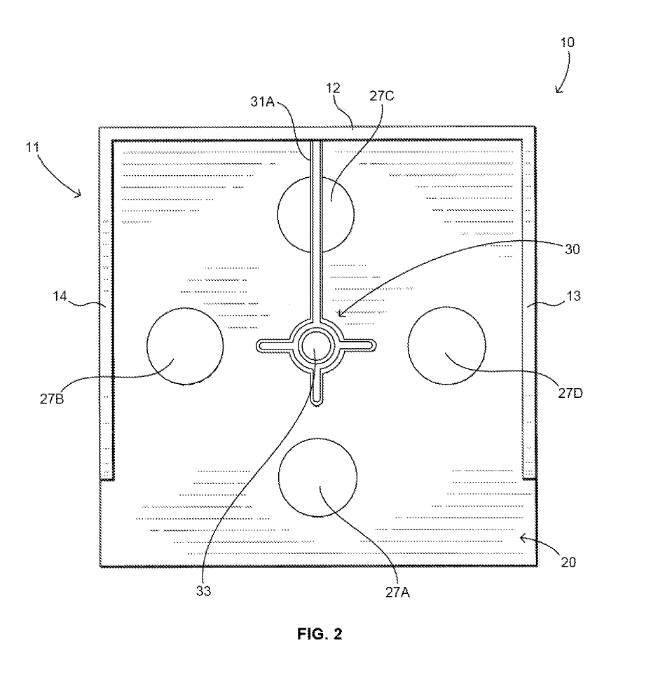

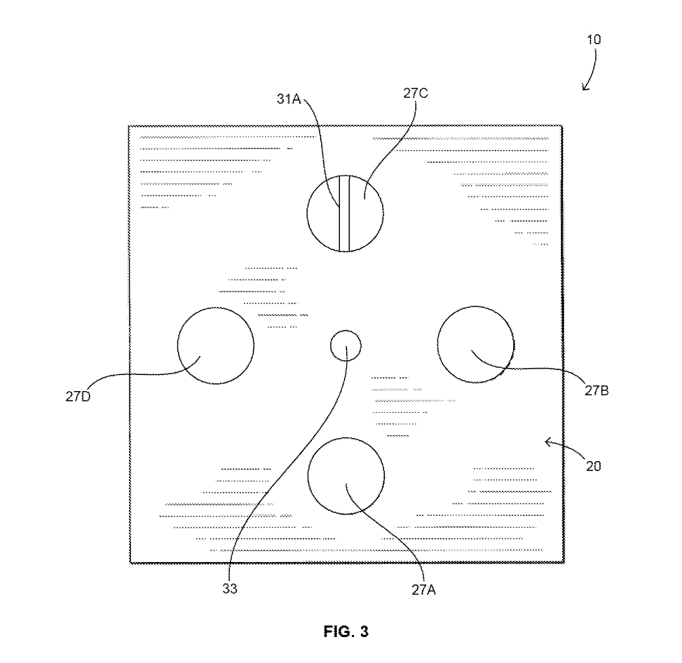

In one embodiment, illustrated in FIGS. 1-4 a covering 10 includes a base 20 having a front surface 21 and a back surface 22, a top edge 23, a bottom edge 24, a right edge 25, a left edge 26, and optionally at least one attachment element 27A, 27B, 27C, 27D. As illustrated, the base has a rectangular shape. However, other shapes are envisioned, certain of which are exemplified below. For example, the back surface 22 may be concave rather than flat, such that the concave surface provides a better surface for engaging with the trunk of a tree.

The covering 10 also includes a cover 11 extending from the front surface 21 of the base 20 and extending along at least a portion of the base. As illustrated in this embodiment, the cover 11 includes a top surface 12 and right and left surfaces 13, 14 which form a portion of a rectangular shape. Further, this embodiment of cover 11 extends along a majority of a perimeter of the base, and thereby generally matches the rectangular shape of the base 20, specifically the top surface of the cover extends along the top edge 23 of the base and the right and left surfaces 13, 14 of the cover extend along at least a portion of the right and left edges 25, 26 of the base, respectively. Of course, the shapes of the base and cover need not match one another, though it is preferable that they do for ease of use and manufacture. While the right and left surfaces 13, 14 are illustrated as extending along a majority of the right and left edges 25, 26 of the base, the right and left surfaces 13, 14 may extend along any portion of the length as desired. It is preferable that the surfaces of the cover be positioned along the perimeter of the base 20 such that the cover allows for a maximum area of the base to be covered and be available for placement of an edible product within the protection of the cover. In one alternative, the cover may not include right and left surfaces 13, 14 at all, and thus, the cover would only have a top portion 12. However, it is preferable that right and left surfaces 13, 14 be present as these surfaces provide additional protection from the elements while not inhibiting access by prey in any substantial manner.

As illustrated in FIGS. 1-4, the surfaces 12, 13, 14 of cover 11 have a generally constant length extending away from base 20. The term “generally” herein is used to except the bottom portions of left and right surfaces 13, 14 which have a slope 15, 16 forming a smooth, curved end of the surfaces which, of course, decreases the length of the surfaces along the slopes. While these surfaces and slopes are essentially identical, they may have different shapes and slopes as desired from those illustrated and/or from one another. Further, the length of the surfaces may differ from one surface to another or along a single surface as desired.

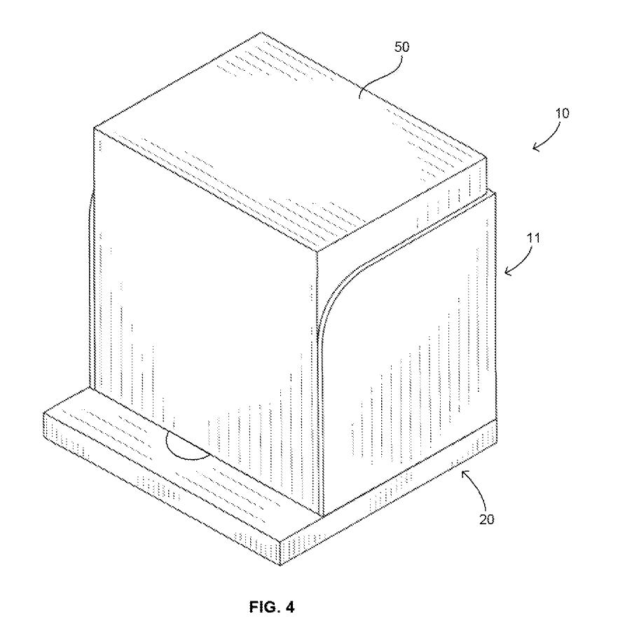

The right, left and top surfaces 12, 13, 14 of cover 11 and the front surface 21 of base 20 partially define an open volume 60 within covering 10, within which an edible product 50 can be positioned, such as in FIG. 4. The base 20 also can include a securing element 30, an example of which is illustrated in FIG. 1, which extends from the front surface 21 of the base 20 and is at least partially enclosed by the cover 11. The securing element 30 can be of any size, shape and design desired such that it can fixedly secure the edible product 50 within the open volume of the covering 10. Alternatively, the edible product could be fixedly secured directly to the base 20 and/or cover 11 through the natural adhesion of the edible product, an adhesive or coating, an interlocking structure, or the like. However, it is preferably that the securing element 30 be included to ensure a strong connection between the covering 10 and the edible product 50.

As illustrated in FIG. 1, the securing element 30 can include a central structure 32 which may include a passageway 33 extending therethrough. While the central structure is illustrated as having a cylindrical shape, other shapes may be desired. Similar to the at least one attachment element 27A, 27B, 27C, 27D discussed above, passageway 33 may also, or alternatively, be an attachment element used for securing the covering 10 to a solid object, such as a tree, as the passageway 33 may extend, as illustrated, through the base 20. At least one fixation member (not shown) may be positioned through any or all of the passageway and attachment element(s) to secure the covering to the solid object. For example, a screw may be positioned through the attachment element(s) which then penetrates the solid object. Alternatively, a string or strap may be passed through the attachment element(s) and tied around the solid object. In another alternative, a single fixation member, such as a bolt or elongated screw, may be passed through passageway 33 and to the solid object and thus the attachment element(s) 27A, 27A, 27C, 27D may not be necessary and as such may not be included on the base 20. Of course, where the fixation member is a bolt, screw, string, or the like, whether positioned through the passageway 33 or attachment element(s) 27A, 27B, 27C, 27D, such a fixation member must be passed through the edible product 50, or otherwise positioned relative to the covering prior to securing the edible product thereon. In an alternative, the one or more attachment elements may include a projection which may simply secure to a head of a screw separately positioned in the solid object (e.g., similar to hanging a picture frame on a wall). In yet another alternative, the at least one attachment element may include threads which can engage a threaded head of a bolt or screw positioned in the tree. In such alternatives, positioning of a fixation member relative to the covering and edible product during manufacture would not be necessary.

The securing element 30 may also include at least one fin 31A, 31B, 31C, 31D extending therefrom. The fin(s) may be of any size, shape, orientation or number desired. The fin(s) may serve to provide additional security for the edible product 50 positioned on the securing element 30. Also, in other alternatives, more than one securing element 30 may be present on the covering 10 as desired.

FIG. 4 illustrates one embodiment of a covered solid, dissolvable edible product including the covering 10 and the edible product 50. The edible product may be any shape desired, though it is preferred that the edible product generally match the shape of the open volume 60 of covering 10, as illustrated. In one alternative, the covering 10 and a plurality of edible products 50 may be provided as a kit, such that an edible product can be positioned within the covering and used, and once the edible product is used, the covering may be reused with another edible product. Alternatively, a single edible product and covering, fixedly secured together during manufacture, may be provided as a single product, whereby once the edible product has dissolved, the covering is disposed of. In still another variation, a plurality of coverings may be provided in a kit which may then be paired with edible product(s). The coverings in the plurality may have the same shape and dimensions as one another or the coverings may be of a variety of shapes and dimensions. Other variations in how the coverings and edible products are provided are also envisioned.

In another embodiment, the present invention includes a method of using the covered, solid, dissolvable edible product including the steps of obtaining the solid, dissolvable edible product 50 and the covering 10. If the covering and edible product are not obtained as a single apparatus (i.e., they do not come from the manufacturer or retailer already assembled), then the method would include fixedly securing the edible product to the covering. The edible product is fixedly secured to the covering by positioning the edible product onto the securing element 30 within the open volume 60 of the covering 10. With the edible product fixedly secured in the covering as a combined single structure, as in FIG. 4, the method next includes securing the covering, and thus the edible product, to a solid object. The securing step may entail using at least one attachment element 27A, 27B, 27C, 27D, 33 by engaging at least one fixation member to the at least one attachment element and the solid object.

The step of securing the covering 10 to a solid object, such as a tree, is preferably performed such that the top surface 12 of the cover 11 is positioned above at least a portion of the edible product 50. The configuration of the covering 10 and edible product 50 of FIG. 4, for example, renders this orientation simple to accomplish since, of course, the back surface 22 of the base 20 would be positioned vertically against the solid object, such as a trunk of a tree, and the top surface 12 would then extend outwardly from the base, perpendicular to the trunk. In this orientation, at least a majority of a top portion of the edible product 50 (aside from the small amount extending out beyond the length of the cover 11, as shown) would be shielded from the elements by the cover 11, while an underside and a front surface of the edible product, for example, along bottom edge 24 of base 20 and the portion facing outward from the covering 10, remains exposed in downward and frontward directions for access by potential prey.

The step of positioning the edible product 50 on the securing element 30 can be performed in a variety of different ways. In one embodiment, the edible product can be formed directly on the covering 10. While this method would typically be performed during manufacture, a user (such as the hunter, in preparing to use the edible product to attract prey) of the edible product 50 could also undertake this process. In this embodiment, the solid, dissolvable edible product may be manufactured using known methods in the art. For example, during manufacture, the edible product may be in liquid form, and once the covering 10 is positioned relative to the liquid edible product, the edible product solidifies. Solidification depends on the type of edible product and may be done by cooling, adding a catalyst, or exposing the liquid to air. For example, a molasses or sugar-based edible product may be heated during processing, and once the covering is positioned in the liquid, is then cooled and allowed to harden and thus fixedly secure to the covering (and specifically the securing element 30, if present). Alternatively, this process may be performed by the user, in that the ingredients are mixed over a heat source, at which time the covering is positioned relative to the liquid and the liquid is allowed to cool such that it forms a solid that is fixedly secured to the covering.

In another embodiment, a solid edible product 50 can be positioned on the securing element through pressure applied by the user to the edible product. Such pressure would force the securing element 30 into the edible product mass, whereby the shape and features of the securing element (e.g., fins 21A, 31B, 31C, 31D) would prevent the edible product from unseating from the securing element and the covering 10. To assist in forcing the edible product onto the covering, the securing element 30 may include a tapered end, or sharp tip, which can assist in penetrating to the solid mass of the edible product. Other methods of fixedly securing the edible product to the covering are also envisioned.

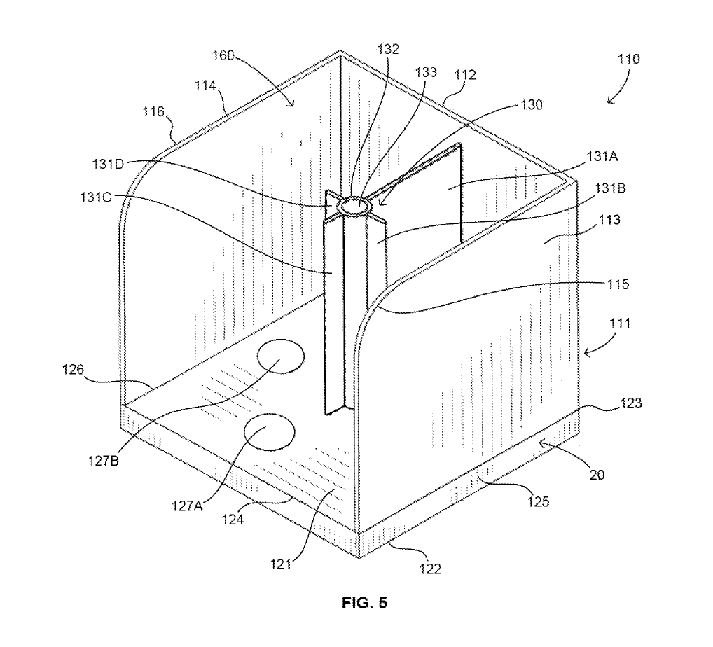

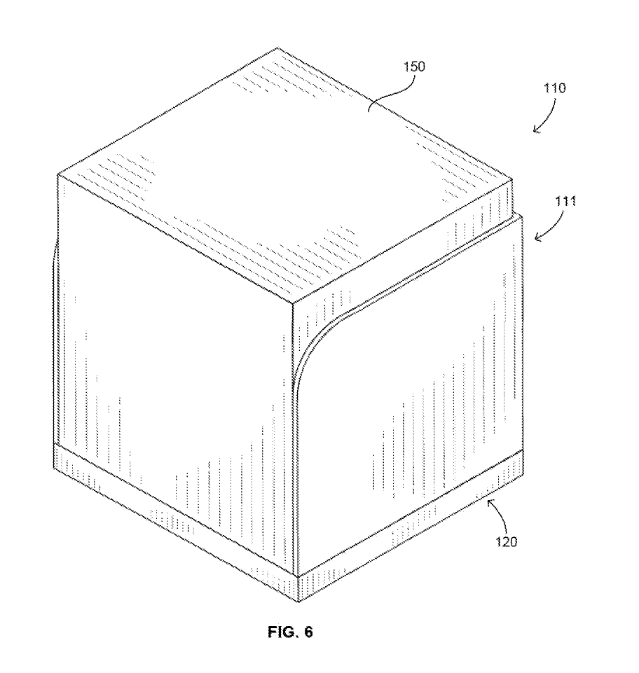

FIGS. 5 and 6 illustrate another embodiment of a covering 110 of the present invention. Covering 110 is similar to covering 10, and as such like reference numbers have been used in both embodiments to designate like features. As such, the above discussion relative to covering 10 applies equally to covering 110, including the above discussions relating to kits and method of manufacture and use.

Covering 110 does differ from covering 10, however, as to the left and right surfaces 113, 114, which in covering 110 extend to the corners of bottom edge 124 of base 120. Similarly, edible product 150, illustrated in FIG. 6, is shown as extending to bottom edge 124 as well. Of course, such an edible product 150 could be used in covering 10, and likewise edible product 50 could be used in covering 110.

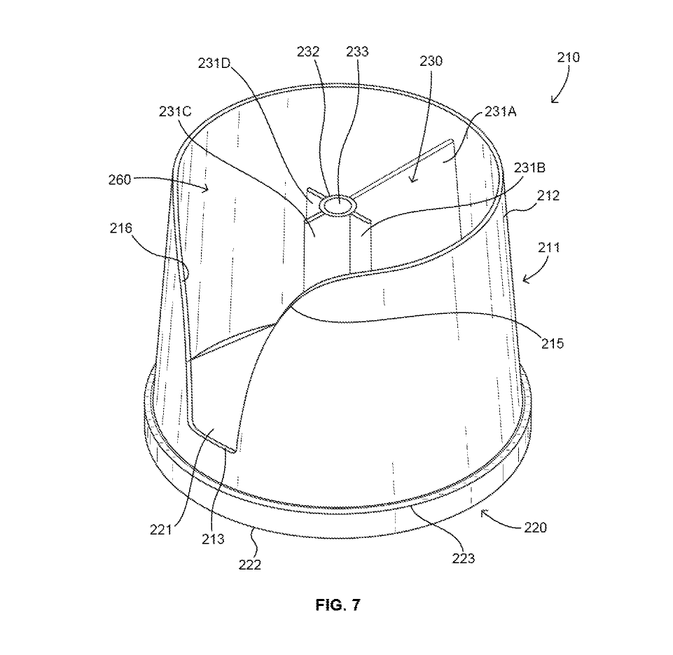

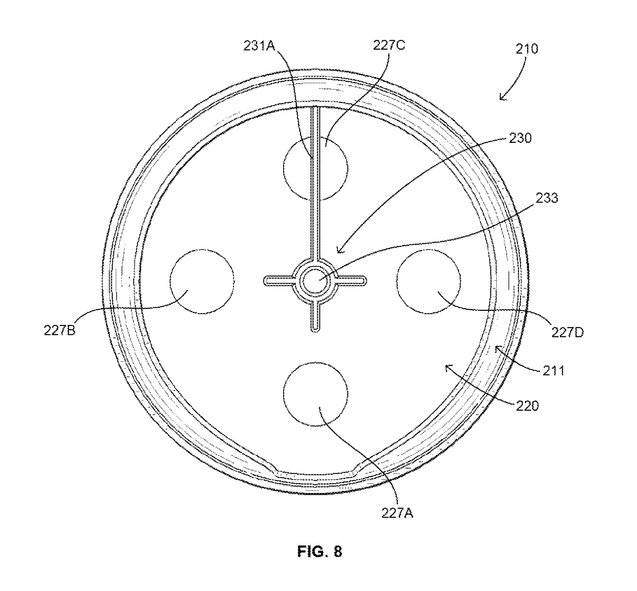

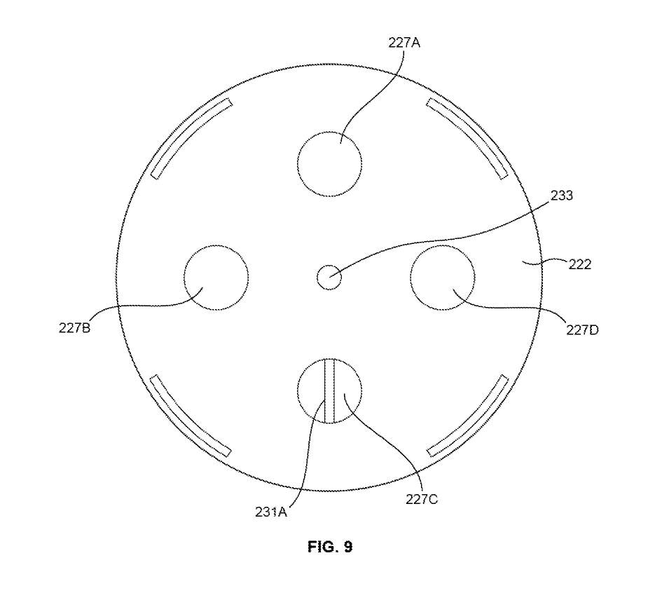

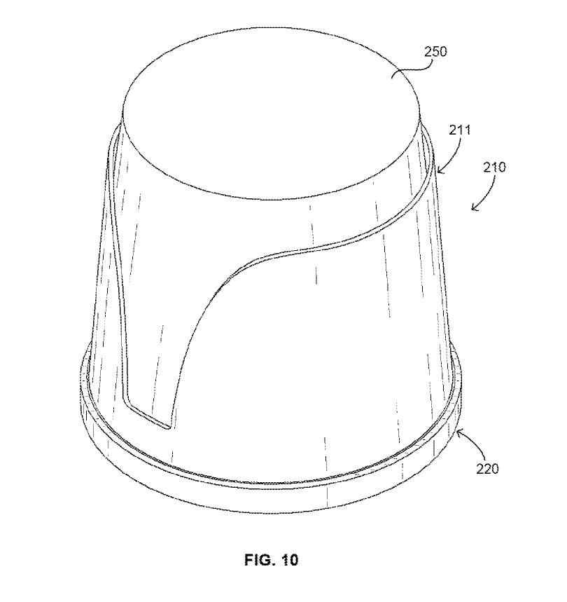

FIGS. 7-10 illustrate yet another embodiment of a covering 210 of the present invention. Like numerals in FIGS. 7-10 as to FIGS. 1-6 denote like elements. In this embodiment, the covering 210 includes a base 220 that has a circular shape and a circumference defined by edge 223, and a cover 211 that can have a conical or cylindrical shape, and which extends along at least a portion of the circumference. As illustrated, the cover can extend around the entirety of the circumference. In an alternative, as in FIGS. 1-6, the cover may extend around a majority of the circumference but not the entirety of the circumference.

The cover 211 includes a first surface 212 having a generally constant length extending away from base 20, similar to surfaces 12, 13, 14 in FIGS. 1-4. However, also as with surfaces 13, 14, cover 211 also includes second and third surfaces 215, 216 that form smooth, curved edges which decrease in length. These surfaces 215, 216 extend to a fourth surface 213 having a generally constant length that is less than the length of the other surfaces 212, 215, 216. Alternatively, as with covers 11, 111, the fourth surface may not be present, and instead the second and third surfaces extend to the base 220. As discussed above, the shorter fourth surface (or complete lack thereof), which would be positioned facing downward when the base 220 is positioned against a solid object, such as a tree trunk, provides access for potential prey to the edible product 250, positioned within the open volume 260. As illustrated, the edible product 250 has a shape similar to the open volume of the covering 210.

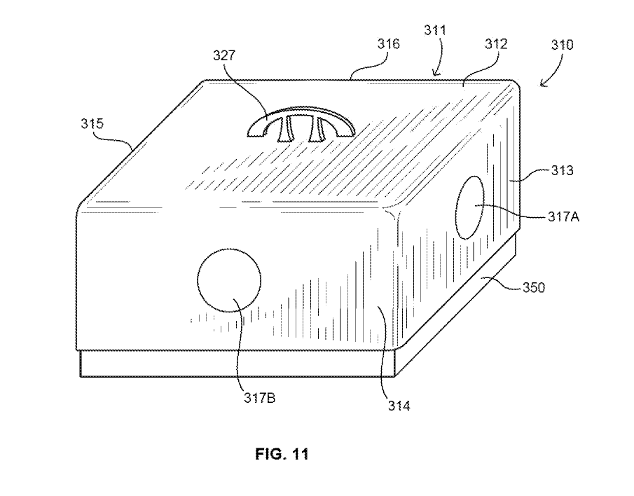

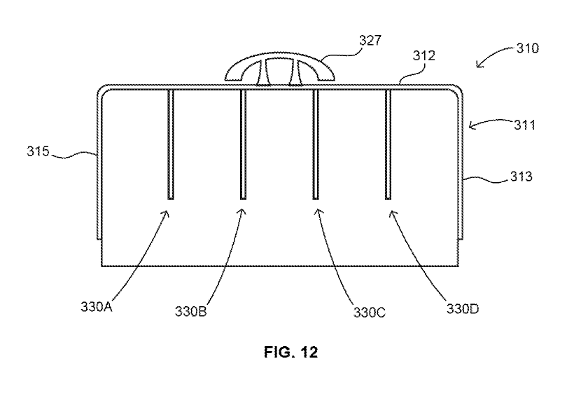

In still another embodiment of the present invention, FIGS. 11 and 12 illustrate a covering 310 including a cover 311 having a top surface 312, and side surfaces 313, 314, 315, 316 extending generally perpendicularly from the top surface 312. The cover 311 defines an open volume within which a solid, dissolvable edible product 350 is positioned. Cover 311 also may include at least one opening 317A, 317B (additional openings can be positioned on side surfaces 315, 316) which provide access to the edible product by potential prey, in addition to access through the open bottom of the cover 311.

Covering 310 may also include a handle 327, or similar structure, suitable for attachment of a string, strap or the like. As such, rather than being secured to a trunk of a tree, as in the above embodiments, covering 310 and edible product 350 may instead be suspended from a solid object, for example, from a branch of a tree, by such a string, strap or the like.

FIG. 12 also illustrates that covering 310, like the above, may also include at least one securing element 330A, 330B, 330B, 330B to fixedly secure the edible product 350 to the covering 310. As illustrated, such securing elements may be planar fins (such as fin 31A, for example in FIG. 1), though other shapes are possible.

Any of the above embodiments of coverings and edible products may be used and manufactured as discussed above. Further, the shapes, dimensions, sizes and orientations of various elements of these embodiments are for exemplary purposes only, and may be altered as desired. For example, a three-sided cover, such as cover 10, 110, may have a trapezoidal shape, and further, the underlying edible product may remain as a rectangular shape or may also be of a trapezoidal shape. Further, multiple types of edible products may be positioned within a single covering, and may be desirable dependent on the type of prey sought by the hunter.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A covering for a solid, dissolvable edible product, comprising:
a base having a front surface, a back surface, and at least one attachment element;
a cover extending from the front surface of the base along at least a portion of the base; and
a securing element extending from the front surface of the base.

2. The covering of claim 1, wherein the securing element includes at least one fin extending therefrom.

3. The covering of claim 1, wherein a passageway extends through the securing element and the base.

4. The covering of claim 1, wherein the cover extends along at least a portion of a perimeter of the base.

5. The covering of claim 4, wherein the cover extends around a majority of the perimeter of the base.

6. The covering of claim 5, wherein the base is rectangular in shape having top, bottom, left and right edges, wherein the cover extends along the top edge and at least a portion of the right and left edges.

7. The covering of claim 6, wherein the cover extends along the entirety of the top edge and along the entireties of the right and left edges.

8. The covering of claim 5, wherein the base is circular in shape and has a circumference, wherein the cover extends along a majority of the circumference.

9. The covering of claim 8, wherein the cover extends around the entirety of the circumference.

10. The covering of claim 9, wherein the cover includes a first surface having a length, wherein the length of the cover is generally constant along a majority of the circumference.

11. The covering of claim 10, wherein a second surface of the cover includes a slope, wherein along this surface the length of the cover decreases according to the slope.

12. The covering of claim 11, wherein a third surface of the cover includes a constant second length, the second length being less than the length of the first surface.

13. The covering of claim 8, wherein the cover is substantially cylindrical or conical.

14. The covering of claim 1, wherein the solid,
dissolvable edible product is a hunting attractant, wherein the securing element fixedly secures the hunting attractant within an open volume partially defined by the base and the cover.

15. A covered solid, dissolvable edible product, comprising:
a covering having an open volume partially defined by a front surface of a base and a cover extending from the front surface of the base, the base having a securing element extending from the front surface, the securing element at least partially enclosed by the cover; and
the solid dissolvable product positioned within the open volume and fixedly secured to the securing element.

16. The covered edible product of claim 15, wherein the edible product is a hunting attractant.

17. The covered edible product of claim 16, wherein the base includes at least one attachment element adapted to secure the base to a solid object.

18. The covered edible product of claim 17, wherein the at least one attachment element includes a passageway extending through the securing element and the base adapted for the positioning of a fixation member therein.

19. The covered edible product of claim 15, wherein the cover extends along at least a portion of a perimeter of the base.

20. A method of using a covered, solid, dissolvable edible product, comprising the steps of:
obtaining the solid, dissolvable edible product and a covering, the covering comprising a base having a front surface and a back surface, and at least one attachment element, a cover extending from the front surface of the base along at least a portion of the base, and a securing element extending from the front surface of the base, the edible product fixedly secured on the securing element within an open volume partially defined by the base and the cover; and
securing the covering and the edible product to a solid object using the at least one attachment element.
